(19) United States
(12) Patent Application Publication
(10) Pub. No.: US 2024/0212373 A1
(43) Pub. Date: Jun. 27, 2024

(54) METHOD FOR ANNOTATING TRACKS OF INDIVIDUALS IN A SEQUENCE OF IMAGES

(71) Applicant: COMMISSARIAT A L’ENERGIE ATOMIQUE ET AUX ENERGIES ALTERNATIVES, PARIS (FR)

(72) Inventors: Guillaume LAPOUGE, GIF-SUR-YVETTE (FR); Bertrand LUVISON, GIF-SUR-YVETTE (FR)

(21) Appl. No.: 18/545,916

(22) Filed: Dec. 19, 2023

(30) Foreign Application Priority Data
Dec. 21, 2022 (FR) 2214033

(51) Int. Cl. G06V 20/70; H04L 9/32

(52) U.S. Cl. CPC G06V 20/70; H04L 9/3247

(57) ABSTRACT

A method for annotating tracks acquired from a camera, includes the following steps: receiving at least one sequence of images acquired using at least one camera, extracting, from the at least one sequence of images, at least one track of an unknown individual, computing, for each track of individuals, a signature of the individual, executing multiple iterations of a constrained partitioning algorithm on the tracks based on their signature, the algorithm being configured to partition the tracks into at least one group of recommended individuals or into a group of individuals without a recommendation, in each new iteration, providing the partitioning algorithm with at least one new constraint and executing a step of validating the identity of the individuals classified in the group of recommended individuals. If the identity of the individual is validated, annotating the individual with this identity and transferring them to a group of annotated individuals.

### CROSS-REFERENCE TO RELATED APPLICATION

This application claims priority to foreign French patent application No. FR 2214033, filed on Dec. 21, 2022, the disclosure of which is incorporated by reference in its entirety.

### FIELD OF THE INVENTION

The invention relates to the field of annotating tracks of individuals, for example animals, in a sequence of images acquired by one or more cameras. The invention relates to an annotation method involving a constrained partitioning algorithm.

One problem to be solved in the field of annotating individuals in sequences of images concerns the consideration of external constraints, for example user constraints or constraints provided by other sensors in order to improve the accuracy of automatic annotations, that is to say reduce the percentage of errors in automatically generated annotations.

### BACKGROUND

Generally speaking, the invention aims to propose an annotation method that is as reliable as possible.

The methods from the prior art are more often than not based on classification or partitioning techniques that do not make it possible to take into account any type of constraints and that operate in a single iteration. Moreover, the known methods do not always take into account multi-camera acquisitions.

The invention proposes a novel method for the semi-automatic annotation of individuals within a sequence of images captured by one or more cameras. The method implements an iterative constrained partitioning technique that makes it possible to improve the accuracy of annotations.

### SUMMARY OF THE INVENTION

One subject of the invention is a computer-implemented method for annotating tracks acquired from at least one camera, the method comprising the following steps:
Receiving at least one sequence of images acquired using at least one camera,
Extracting, from the at least one sequence of images, at least one track of an unknown individual,
Computing, for each track of individuals, a signature of the individual,
Executing multiple iterations of a constrained partitioning algorithm on said tracks based on their signature, the algorithm being configured to partition the tracks into at least one group of recommended individuals or into a group of individuals without a recommendation,
In each new iteration, providing the partitioning algorithm with at least one new constraint and executing a step of validating the identity of the individuals classified in the group of recommended individuals,
If the identity of the individual is validated, annotating the individual with this identity and transferring them to a group of annotated individuals.

In one variant embodiment, the method according to the invention furthermore comprises a step of receiving a database consisting of tracks of annotated individuals, the computing of an individual signature and the partitioning algorithm being implemented for the tracks of annotated and unknown individuals, each group of recommended individuals comprising an annotated individual.

According to one particular aspect of the invention, the validation step consists in validating the identity of the individuals classified in the group of recommended individuals as corresponding to the identity of the annotated individual.

According to one particular aspect of the invention, the step of validating the identity of the individuals classified in the group of recommended individuals is carried out by way of a user interaction or by way of a rule for comparing between the respective signatures of the individual whose identity is to be validated and of the annotated individual.

In one variant embodiment, the method according to the invention comprises a step of supplementing the database with the tracks of the group of annotated individuals.

According to one particular aspect of the invention, the at least one sequence of images is acquired by way of multiple cameras with joined fields or with disjoint fields.

According to one particular aspect of the invention, the tracks of individuals are generated in 2D or 3D.

According to one particular aspect of the invention, the step of computing a signature for each track of individuals is carried out by way of a reidentification neural network trained to generate similar signatures for identical individuals.

In one variant embodiment, the method according to the invention furthermore comprises a step of retraining the reidentification neural network from the database of tracks of individuals obtained at the end of multiple iterations of the annotation method.

In one variant embodiment, the method according to the invention furthermore comprises a step of receiving constraints provided by at least one sensor and associated with the tracks of individuals, including: a constraint on the temporal and/or spatial localization of an individual, a constraint relating to the identity of the individual, a constraint on non-ubiquity of an individual, a constraint on non-teleportation of an individual, said constraints being provided at input of the constrained partitioning algorithm.

In one variant embodiment, the method according to the invention furthermore comprises, in each iteration, a step of receiving user constraints associated with the tracks of individuals, relating to the identity of an individual, said constraints being provided at input of the constrained partitioning algorithm.

According to one particular aspect of the invention, the constraints on the partitioning algorithm are taken from among a constraint on association between multiple tracks of individuals or a constraint on non-association between multiple tracks of individuals.

According to one particular aspect of the invention, all of the tracks that share a constraint on association are grouped into the same group of recommended individuals.

According to one particular aspect of the invention, two tracks that share a constraint on non-association are placed in two different groups of individuals.

Another subject of the invention is a computer program comprising instructions for executing the method according to the invention when the program is executed by a processor.

Another subject of the invention is a processor-readable recording medium on which there is recorded a program comprising instructions for executing the method according to the invention when the program is executed by a processor.

### BRIEF DESCRIPTION OF THE DRAWINGS

Other features and advantages of the present invention will become more clearly apparent on reading the following description with reference to the following appended drawings.

FIG. 1a shows a flowchart detailing the steps for implementing a method for annotating tracks of individuals according to a first embodiment of the invention,

FIG. 1b shows a flowchart detailing the steps for implementing a method for annotating tracks of individuals according to a second embodiment of the invention,

FIG. 2 shows one example of a track of an animal,

FIG. 3 shows a flowchart detailing the phases of implementing a partitioning step of the method for annotating tracks, according to one embodiment of the invention,

FIG. 4 shows a graphical interface illustrating one example of intermediate results obtained by the method according to the invention,

FIG. 5a shows one exemplary implementation of the partitioning method according to the invention,

FIG. 5b shows one exemplary implementation of the partitioning method according to the invention,

FIG. 5c shows one exemplary implementation of the partitioning method according to the invention,

FIG. 5d shows one exemplary implementation of the partitioning method according to the invention,

FIG. 5e shows one exemplary implementation of the partitioning method according to the invention.

### DETAILED DESCRIPTION

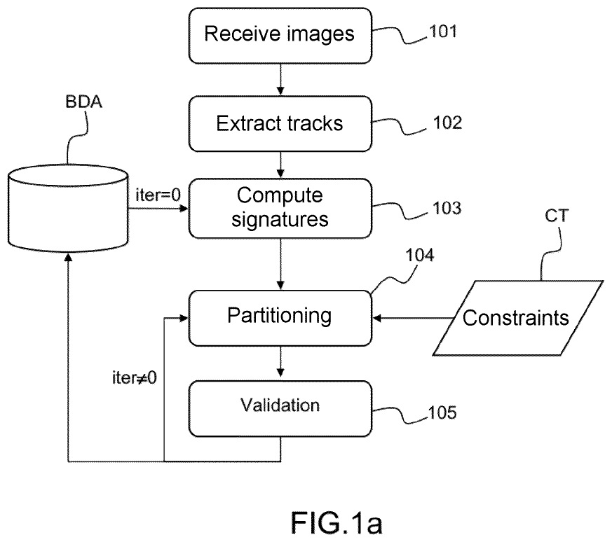

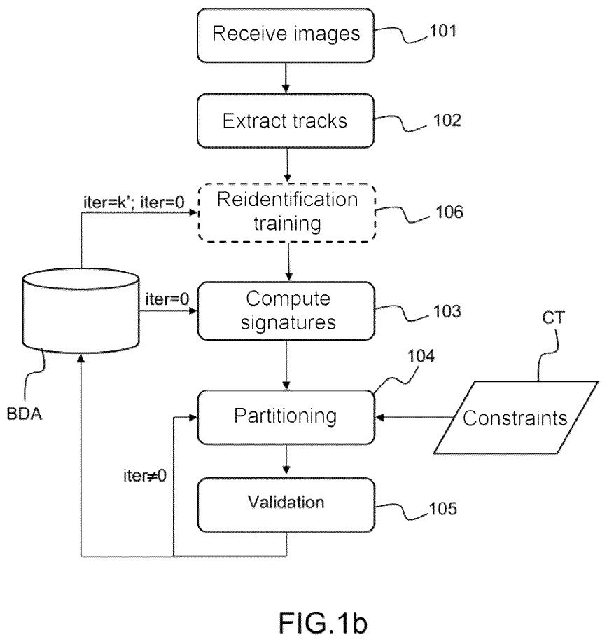

FIG. 1a schematically shows, on a flowchart, the main steps for carrying out annotation of tracks of individuals according to one embodiment of the invention.

The method aims to annotate tracks of individuals, for example animals, with an identity. In other words, one aim of the invention is to identify and annotate accordingly each individual in a given video sequence. One application of the invention consists for example in identifying each individual in a herd of animals.

The method begins in step 101 with the reception of one or more sequences of images acquired by one or more cameras. When multiple cameras are used, these may have joined fields or disjoint fields. The tracking may be carried out in 2D or 3D. To this end, any video sequence acquisition device that makes it possible to provide 2D or 3D tracking is compatible with the invention.

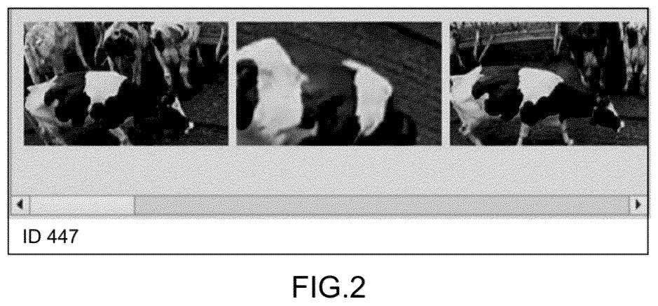

In step 102, tracks of individuals are then extracted from the captured sequences of images. One example of a track of an individual is shown in FIG. 2. A track consists of consecutive position and time information along with multiple thumbnails centred on the individual to be tracked. Each thumbnail is associated with an instant in time. Step 102 may be carried out by way of any track generation algorithm, for example a “Multi Object Tracking” or MOT tracking algorithm, as described for example in references [1], [2] or [3].

In the case of 3D tracking, the generation of tracks may be based for example on a first step of generating 2D tracks in calibrated cameras, and then a second step of carrying out estimation in 3D based on a height hypothesis on the 2D observation. In the case of cameras with joined fields, two 3D projections from two different cameras observing the same region may be correlated using the Hungarian algorithm, for example.

Step 102 may be carried out with 2D or 3D tracking and for sequences captured by cameras with joined or disjoint fields.

One aim of step 102 is to provide at output as many tracks as there are individuals present in the filmed scene. Each track is associated with a single individual. Each track is a localized temporal sequence that identifies the trajectory of an individual in time and space. Multiple tracks may be associated with the same individual, for example, in different time intervals.

One aim of the invention is to annotate each track by assigning it an identity, for example a number.

In one embodiment of the invention, the method also receives at input an annotated database BDA consisting of tracks of already annotated individuals. The data in the database BDA may be annotated manually, by a user, or automatically using the method according to the invention. More generally, one aim of the invention is also to supplement the database BDA with new annotated tracks. An annotated track is a track of the type described in FIG. 2 with which there is associated an identity, for example ID 447 in the example of FIG. 2.

Optionally, the invention may also be applied without relying on an annotated database BDA, in which case all of the identities of the individuals are initially unknown.

In step 103, a visual reidentification signature is then computed for each track resulting from the track extraction step 102, but also for each track in the database BDA when said database is available. Advantageously, the signatures for the tracks or thumbnails stored in the database BDA are computed only in the first iteration (iter=0) of the method, and are then saved for the following iterations.

A signature is computed for each track in order to evaluate the similarity between the various tracks. The signature computing step 103 is for example implemented by way of a reidentification algorithm as described for example in one of references [4] or [5].

The reidentification algorithm may implement an artificial intelligence model trained to compute a signature characteristic of the visual appearance of each thumbnail of the track. Such an algorithm is trained to compute substantially identical signatures for two thumbnails representing the same individual and, conversely, different signatures for two thumbnails representing different individuals. For example, the signature is computed from points of interest characteristic of the visual appearance of the individual.

The artificial intelligence model is for example based on a convolutional neural network or a transformer neural network.

The neural network takes the images of the track at input and encodes them in a feature space of smaller dimension so as to generate features, or signatures, which encode the relevant visual information so as to be able to compare various identities with one another.

The neural network is for example trained with supervision from a training database containing, for each identity, multiple different thumbnails representing the individual in various conditions.

The training base is for example a public training image base.

The neural network is trained so as to minimize a predetermined cost function. The parameters of the network, comprising the synaptic weights of each layer of the network, are learned by way of a gradient backpropagation algorithm consisting in backpropagating the error obtained based on the cost function from the output of the network to the input while progressively updating the parameters of each layer.

The cost function that is used is for example equal to

$${L}_{T r i} = max ( {d}_{p} - {d}_{n} + α , 0 )$$

dₚ corresponds to a distance between the signatures computed for a reference image and another image corresponding to the same identity as the reference image. dₙ corresponds to a distance between the signatures computed for a reference image and another image corresponding to an identity different from that of the reference image.

α is a parameter corresponding to an inter-identity margin.

Minimizing the cost function LTri makes it possible to ensure that an intra-identity distance is greater than an inter-identity distance.

Another cost function may be used on its own or in addition to the previous one and corresponds to a classification function. The reidentification signatures are provided to a classification neural network the size of which at output is equal to the number of identities N contained in the learning base.

The cost function to be minimized is given by:

$${L}_{ID} = {\sum }_{i = 1}^{N} - {q}_{i} log ( {p}_{i} )$$

### With,

$${q}_{i} = 0 if y \neq i$$

$${q}_{i} = 1 if y = i$$

Where pᵢ is the logit corresponding to the prediction of an identity belonging to the class i, and y is the true identity of the individual under consideration.

For example, the signature of a track is computed as the average of the signatures computed for each image of the track.

The signature of an identity present in the annotated database is for example equal to the average of the signatures computed for each image representing this identity.

In step 104, a partitioning algorithm is then applied to all of the signatures computed in step 103. The partitioning algorithm is configured to partition the signatures into various groups, potentially corresponding to different identities. One aim of the partitioning step 104 is that all of the signatures classified in the same group are supposed to correspond to the same identity. However, the partitioning algorithm 104 may have a certain percentage of partitioning errors, which is why it operates with constraints CT, operates iteratively and is associated with a validation step 105 of validating the estimated identities.

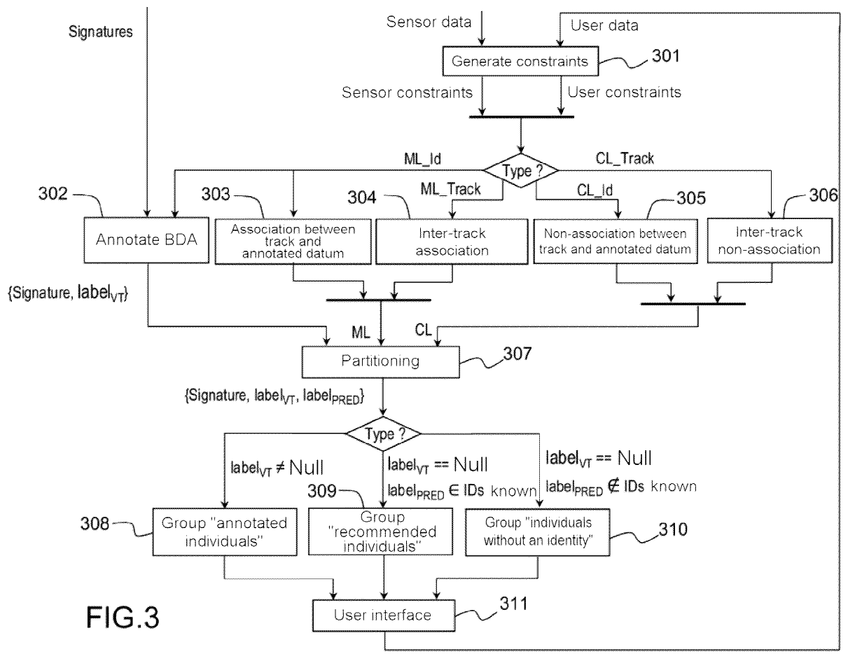

FIG. 3 shows, on a flowchart, the steps for implementing the partitioning algorithm of step 104.

The algorithm receives at input the signatures computed for both the annotated tracks and the non-annotated tracks.

It also receives data from sensors that make it possible to provide spatial and/or temporal localization information in relation to the individuals along with information relating to the identity of the individuals. The information may be absolute or relative (comparison between identities).

For example, the data provided by sensors are taken from the following non-exhaustive list:
One-off localization information in relation to an individual, provided by an RFID sensor or a QR code and associated with an absolute identity,
Long-term localization information provided by a satellite positioning sensor or by an ultra-wideband localization device and associated with an absolute identity. The localization information is continuous and associated with a pair (time, position).

The algorithm may also receive data provided by a user relating to the absolute or relative identity of the individuals. These user data are taken from the following non-exhaustive list:
“Positive” absolute identification information generated by a user who makes an association between a track (or an image of this track) and an absolute identity and indicates that the same individual is involved,
“Negative” absolute identification information generated by a user who makes an association between a track (or an image in this track) and an absolute identity by indicating that a different individual is involved,
“Positive” relative identification information generated by a user who makes an association between multiple tracks and indicates that the same individual is involved, without providing an absolute identity,
“Negative” relative identification information generated by a user who makes an association between multiple tracks and indicates that a different individual is involved, without providing an absolute identity.

Generally speaking, the information is for example provided by a user by way of an interaction via a graphical human-machine interface.

All of the data from sensors or users are provided at input of a constraint generation step 301, which delivers at output a set of constraints to be taken into account by the partitioning algorithm.

Step 301 aims to transform the information received at input into constraints to be taken into account to carry out the partitioning.

The generated constraints are for example taken from the following non-exhaustive list:
A constraint on association between a track and an identity ML_Id: this constraint is generated for example when identification information is available for a track (provided by an identification or localization device or by a user),
A constraint on association between two tracks ML_track: this constraint is generated for example when a user indicates that two tracks should correspond to the same identity,
A constraint on non-association between a track and an identity CL_Id: this constraint is generated for example from user or sensor information,
A constraint on non-association between two tracks CL_track: this constraint is generated for example from spatio-temporal indications relating to constraints on non-ubiquity or non-teleportation.

In particular, certain constraints on the spatio-temporal evolution of an individual in the scene may be taken into account. For example, a first constraint on non-ubiquity may be taken into account in order to avoid the assignment of the same identity to two individuals present at the same time in two different images. A second constraint on non-teleportation or non-displacement at high speed consists in verifying a certain coherence in the spatio-temporal displacement of an individual.

For example, a constraint on non-ubiquity may be computed as follows.

If tₛ₁, tₑ₁ and tₛ₂, tₑ₂ are used to denote the start and end times of two tracks 1 and 2. A constraint on non-ubiquity to be complied with is given by the following relationship: [tₛ₁, tₑ₁]∩[tₛ₂, tₑ₂]=∅. In other words, the two tracks 1 and 2 cannot be associated with the same identity if this relationship is not complied with. Thus, if this condition is not satisfied, a constraint on non-association is generated for these two tracks.

In the same way, for a track 1 earlier than a track 2, if posₛ₁, posₑ₁ are used to denote the respective start and end positions of an individual in a track 1 and posₛ₂, posₑ₂ are used to denote the respective start and end positions of an individual in a track 2, a constraint on non-teleportation or non-displacement at high speed vₘₐₓ to be complied with may be given by the following relationship:

$$( {‖ {pos}_{s 2} - {pos}_{e 1} ‖}_{2} ) / ( {t}_{s 2} - {t}_{e 1} ) < {v}_{max}$$

If this condition is not satisfied, a constraint on non-association is generated for the two tracks 1, 2.

In addition to the abovementioned constraints, the user may decide to assign a new identity, never seen previously, to a track. This means the discovery of a previously undeclared identity.

These constraints are then translated into inter-track constraints.

In other words, any track having a constraint on association with an identity i ∈ [1; N_k] is linked to the tracks annotated with this identity i by a constraint on association. N_k being the number of annotated identities in partitioning iteration k (iter=k).

Any track having a constraint on absence of association with an identity i ∈ [1; N_k] is linked to the tracks annotated with this identity i by a constraint on non-association.

These inter-track associations are carried out by steps 303, 304, 305, 306.

Step 302 aims to associate a ground truth label labelvt with all of the signatures computed for the identities in the annotated database BDA.

In step 307, the partitioning algorithm is executed with, as inputs, all of the signatures and constraints to be complied with.

The partitioning algorithm that is used is for example the C-DBSCAN algorithm described in reference [6] or a constrained hierarchical partitioning algorithm described in [7].

The partitioning algorithm 307 is configured to classify tracks into two types of groups.

Tracks that are classified in the same group as an image in the database BDA associated with a known identity are classified in a group 309 of recommended individuals associated with this identity. They correspond to individuals who are unknown but who resemble a known individual due to the similarity between their signatures.

Tracks that belong to a group that does not contain any signature associated with a known identity (from the database BDA) are classified in a group of individuals without an identity 310. These are unknown individuals who were not able to be assigned to a known identity, that is to say present in the database BDA.

In one variant embodiment, if no annotated database is initially available, in the first iteration of the method (iter=0), all of the individuals are classified in the group without an identity 310.

An additional step of validating the identity of the individuals in the group 309 of recommended individuals is then carried out in order to transfer or not transfer these individuals to the group 308 of annotated individuals by validating their identity as a definitive annotation.

The group 308 of annotated individuals corresponds, in FIG. 3, to the individuals annotated in step 302, that is to say those who possess an identity corresponding to a ground truth labelvt. The individuals in the group of recommended individuals 309 do not yet have an identity associated with a ground truth (that is to say validated as such), but have an estimated identity labelpred.

In one embodiment of the invention, this validation step is integrated into the partitioning algorithm 307 and consists for example in validating the identity of a recommended individual when the difference between their signature and the signature of the annotated individual corresponding to the recommended identity is less than a predetermined threshold.

In another embodiment of the invention, the validation step is carried out via an interaction with a user (step 311). In this embodiment, the tracks of the group of recommended individuals are presented to the user via a graphical interface. They are displayed next to the corresponding images of the same identity in the database BDA, and the user then validates or does not validate, through visual evaluation, whether or not the estimated identity corresponds to the real identity. If it does, the tracks are definitively annotated with this identity and move to the group of annotated individuals 308. In this case, the tracks are then saved in the annotation database BDA in order to enrich it.

The method operates as an iterative process. In each iteration i, a user may not only carry out the step of validating the identities of the recommended individuals, but also provide new constraints to the partitioning algorithm, for example constraints on association or non-association between various tracks. If an estimated identity of an individual is not validated by the user, this information is provided to the partitioning algorithm in the form of a constraint on non-association between the track and the estimated identity for the next iteration.

This iterative operation is shown schematically in FIG. 1a by an arrow that loops back from the validation step 105 to the partitioning step 104.

If no annotated database BDA is initially available, starting from the 2^{nd} iteration of the method, the tracks of individuals in the group of annotated individuals 308 (that is to say validated by the user) may be used to create an annotated database BDA that is taken into account for the following iterations. The database BDA is then enriched in each iteration. This iterative operation is shown in FIG. 1a by an arrow that goes from the validation step 105 to the database BDA.

In another embodiment of the invention shown in FIG. 1b, the reidentification algorithm used to compute the signatures 103 is retrained in step 106 on the data updated in the database BDA after k′ iterations of the partitioning mechanism (iter=k′ iterations). Retraining the reidentification model makes it possible to compute signatures that are better suited to partitioning the data in a given space related to the types of individuals to be annotated. In this embodiment, once the reidentification network has been retrained (step 106), the iterative partitioning method according to the invention as described in FIG. 1a is executed again in its entirety.

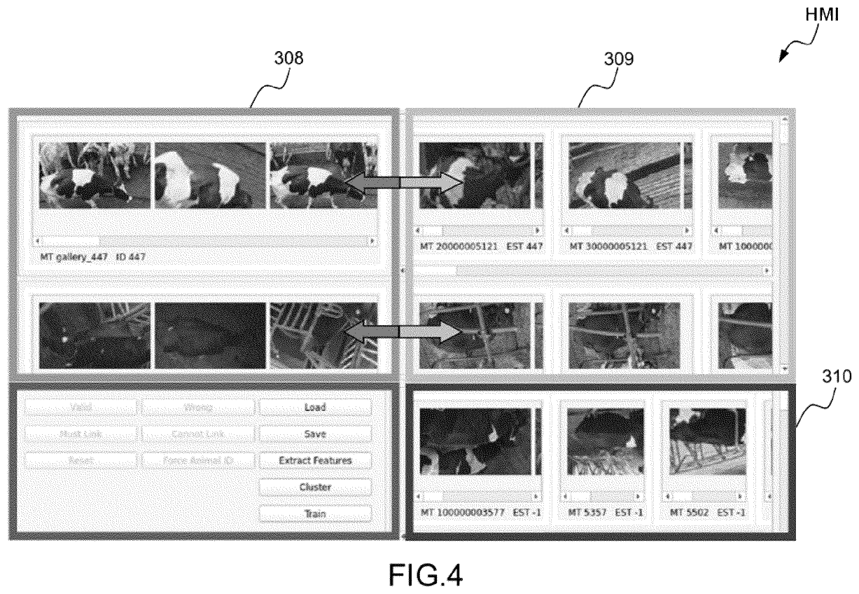

FIG. 4 shows one example of a graphical human-machine interface HMI. This interface comprises a first pane for visualizing the group of annotated individuals 308 in the form of tracks associated with an identity ID.

It comprises a second pane for visualizing the group of recommended individuals 309 with estimated identities EST. The tracks of individuals in the group 309 are visualized on the same row as the tracks of individuals in the group 308 corresponding to the same identities. The user is thus able to more easily compare the tracks in pairs in order to validate the estimated identities.

The graphical interface HMI lastly comprises a third pane 310 including the tracks of the group of individuals without an identity 310.

In each iteration, the user may also assign a new identity ID to the tracks of the group of individuals without an identity 310. In this case, these tracks may be transferred to the group of annotated individuals 308.

One advantage of the proposed method lies in its iterative operation, which makes it possible to progressively improve the annotations of the tracks by introducing user constraints in each iteration.

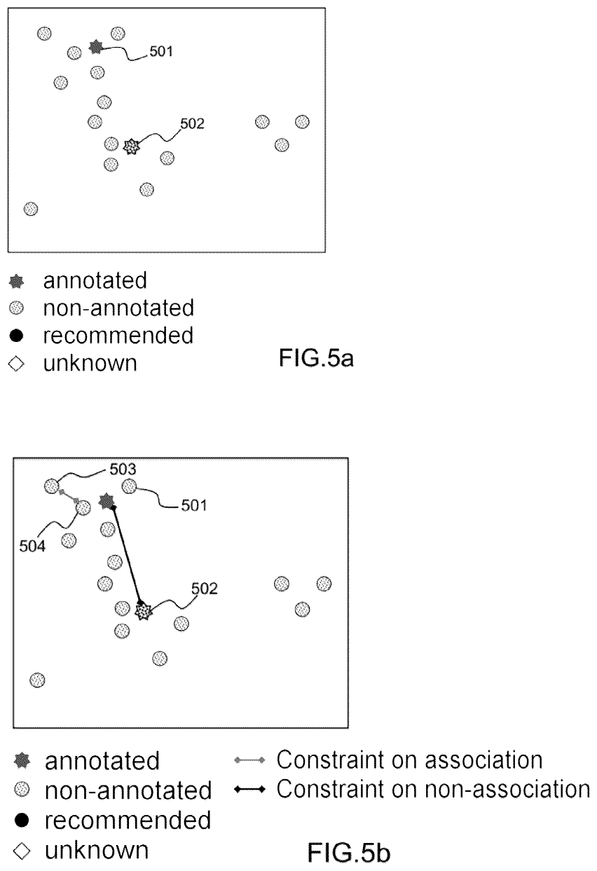

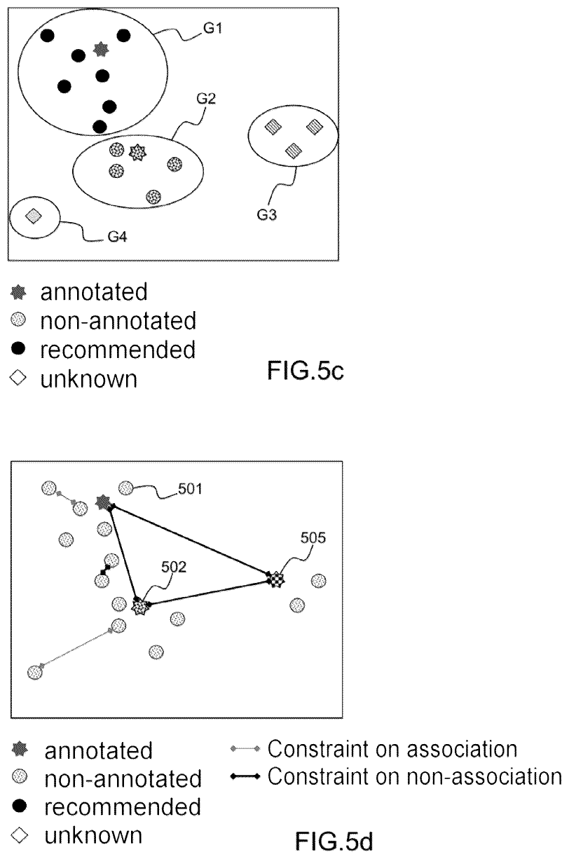

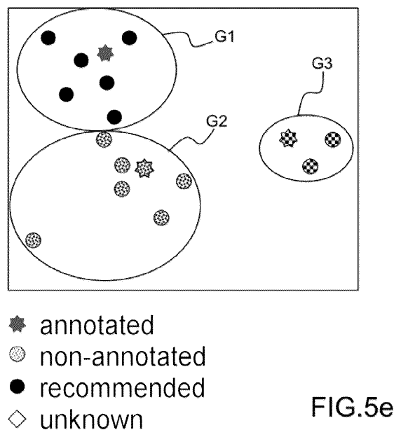

FIGS. 5a to 5e illustrate the iterative operation of the method according to the invention on a non-limiting schematic example.

FIG. 5a schematically shows a set of symbols corresponding to tracks provided at input of the partitioning step 307 of the algorithm of FIG. 3. In the example of FIG. 5a, all of the tracks are non-annotated (resulting from new acquisitions) except for the tracks 501 and 502, which are already annotated and correspond to two different identities.

FIG. 5b illustrates the application of constraints to the various tracks. In this example, the tracks 501 and 502 are linked by a constraint on non-association, since they correspond to two different identities. The tracks 503 and 504 are linked by a constraint on association.

The constraints result from information from sensors or a priori information.

FIG. 5c shows the result of a first partitioning iteration that leads to the establishment of four groups G1, G2, G3, G4 that take into account the abovementioned constraints.

FIG. 5d shows a second iteration of the method, which begins with the introduction of new constraints provided by the user. In this case, the track 505 is identified by the user, who assigns it a new identity. The already annotated tracks 501, 502, 505 are constrained by a constraint on non-association, since they correspond to three different identities. Other constraints on association and non-association are introduced for pairs of tracks.

FIG. 5e shows the result of the second partitioning iteration, which leads to the groups being refined. In this example, three groups G1, G2, G3 are finally formed rather than the four groups obtained in the first iteration, which did not benefit from all of the constraints provided by the user.

The invention may be implemented as a computer program comprising instructions for the execution thereof. The computer program may be recorded on a processor-readable recording medium.

The reference to a computer program that, when it is executed, performs any one of the functions described above is not limited to an application program running on a single host computer. On the contrary, the terms computer program and software are used here in a general sense to refer to any type of computer code (for example application software, firmware, microcode, or any other form of computer instruction) that may be used to program one or more processors to implement aspects of the techniques described here. The computing means or resources may notably be distributed (“Cloud computing”), possibly using peer-to-peer technologies. The software code may be executed on any suitable processor (for example a microprocessor) or processor core or set of processors, be these provided in a single computing device or distributed among multiple computing devices (for example as possibly accessible in the environment of the device). The executable code of each program allowing the programmable device to implement the processes according to the invention may be stored for example in the hard drive or in read-only memory. Generally speaking, the one or more programs will be able to be loaded into one of the storage means of the device before being executed. The central processing unit is able to command and direct the execution of the software code portions or instructions of the one or more programs according to the invention, which instructions are stored in the hard drive or in the read-only memory or else in the other abovementioned storage elements.

### REFERENCES

[1]: A. Bewley, G. Zongyuan, F. Ramos, and B. Upcroft, “Simple online and realtime tracking”, in IEEE international conference on image processing (ICIP), 2016, pp. 3464-3468.
[2]: N. WOJKE, A. BEWLEY and D. PAULUS. “Simple online and realtime tracking with a deep association metric”. In: 2017 IEEE international conference on image processing (ICIP), 2017. pp. 3645-3649.
[3]: Y. ZHANG, P. SUN, Y. JIANG et al. Bytetrack: Multi-object tracking by associating every detection box. In: European Conference on Computer Vision. Springer, Cham, 2022. p. 1-21.
[4] H. LUO, Y. GU, LIAO, Xingyu, et al. Bag of tricks and a strong baseline for deep person re-identification. In: Proceedings of the IEEE/CVF conference on computer vision and pattern recognition workshops. 2019. p. 0-0.
[5] Transreid HE, Shuting, LUO, Hao, WANG, Pichao, et al. Transreid: Transformer-based object re-identification. In: Proceedings of the IEEE/CVF international conference on computer vision. 2021. p. 15013-15022.),
[6] RUIZ, Carlos, SPILIOPOULOU, Myra, and MENASALVAS, Ernestina. C-dbscan: Density-based clustering with constraints. In: International workshop on rough sets, fuzzy sets, data mining, and granular-soft computing. Springer, Berlin, Heidelberg, 2007. p. 216-223.
[7] DAVIDSON, Ian and RAVI, S. S. Agglomerative hierarchical clustering with constraints: Theoretical and empirical results. In: European Conference on Principles of Data Mining and Knowledge Discovery. Springer, Berlin, Heidelberg, 2005. p. 59-70.

1. A computer-implemented method for annotating tracks acquired from at least one camera, the method comprising the following steps:
receiving at least one sequence of images acquired using at least one camera,
extracting, from the at least one sequence of images, at least one track of an unknown individual,
computing, for each track of individuals, a signature of the individual,
executing multiple iterations of a constrained (CT) partitioning algorithm on said tracks based on their signature, the algorithm being configured to partition the tracks into at least one group of recommended individuals or into a group of individuals without a recommendation,
in each new iteration, providing the partitioning algorithm with at least one new constraint (CT) and executing a step of validating the identity of the individuals classified in the group of recommended individuals,
if the identity of the individual is validated, annotating the individual with this identity and transferring them to a group of annotated individuals.

2. The method for annotating tracks according to claim 1, furthermore comprising a step of receiving a database (BDA) consisting of tracks of annotated individuals, the computing of an individual signature and the partitioning algorithm being implemented for the tracks of annotated and unknown individuals, each group of recommended individuals comprising an annotated individual.

3. The method for annotating tracks according to claim 2, wherein the validation step consists in validating the identity of the individuals classified in the group of recommended individuals as corresponding to the identity of the annotated individual.

4. The method for annotating tracks according to claim 3, wherein the step of validating the identity of the individuals classified in the group of recommended individuals is carried out by way of a user interaction or by way of a rule for comparing between the respective signatures of the individual whose identity is to be validated and of the annotated individual.

5. The method for annotating tracks according to claim 2, comprising a step of supplementing the database (BDA) with the tracks of the group of annotated individuals.

6. The method for annotating tracks according to claim 1, wherein the at least one sequence of images is acquired by way of multiple cameras with joined fields or with disjoint fields.

7. The method for annotating tracks according to claim 1, wherein the tracks of individuals are generated in 2D or 3D.

8. The method for annotating tracks according to claim 1, wherein the step of computing a signature for each track of individuals is carried out by way of a reidentification neural network trained to generate similar signatures for identical individuals.

9. The method for annotating tracks according to claim 8, furthermore comprising a step of retraining the reidentification neural network from the database (BDA) of tracks of individuals obtained at the end of multiple iterations of the annotation method.

10. The method for annotating tracks according to claim 1, furthermore comprising a step of receiving constraints provided by at least one sensor and associated with the tracks of individuals, including: a constraint on the temporal and/or spatial localization of an individual, a constraint relating to the identity of the individual, a constraint on non-ubiquity of an individual, a constraint on non-teleportation of an individual, said constraints being provided at input of the constrained partitioning algorithm.

11. The method for annotating tracks according to claim 1, furthermore comprising, in each iteration, a step of receiving user constraints associated with the tracks of individuals, relating to the identity of an individual, said constraints being provided at input of the constrained partitioning algorithm.

12. The method for annotating tracks according to claim 1, wherein the constraints on the partitioning algorithm are taken from among a constraint on association between multiple tracks of individuals or a constraint on non-association between multiple tracks of individuals.

13. The method for annotating tracks according to claim 12, wherein all of the tracks that share a constraint on association are grouped into the same group of recommended individuals.

14. The method for annotating tracks according to claim 12, wherein two tracks that share a constraint on non-association are placed in two different groups of individuals.

15. A computer program comprising instructions for executing the method according to claim 1 when the program is executed by a processor.

16. A processor-readable recording medium on which there is recorded a program comprising instructions for executing the method according to claim 1 when the program is executed by a processor.
